(19) United States
(12) Patent Application Publication
(10) Pub. No.: US 2012/0083919 A1
(43) Pub. Date: Apr. 5, 2012

(54) SIMULATION TOOL FOR DESIGNING CONTROL INTELLIGENCE IN COMPOSITE CURING MANUFACTURING

(75) Inventors: Francisco P. Maturana, Mayfield Heights, OH (US); Raymond J. Staron, Chagrin Falls, OH (US); Danny L. Carnahan, Hudson, OH (US); Kenwood H. Hall, Hudson, OH (US)

(73) Assignee: ROCKWELL AUTOMATION TECHNOLOGIES, INC., Mayfield Heights, OH (US)

(21) Appl. No.: 12/894,970

(22) Filed: Sep. 30, 2010

(51) Int. Cl. G05B 13/04; G05D 23/19

(52) U.S. Cl. 700/211; 700/31

(57) ABSTRACT

Aspects describe creation of autonomous control for a composite curing process. Other aspects describe an intelligent industrial controller that can utilize a control model and a supervisory model to autonomously control the composite curing process. The control model can include intelligent agents corresponding to the physical elements of the composite curing process arranged in a hierarchical manner. For example, an autoclave agent can correspond to the autoclave, and the autoclave agent can be superior to a plurality of thermocouple agents corresponding to a plurality of thermocouples in a one-to-one fashion. The supervisory model can include diagnostic aspects for the composite curing process. For example, the supervisory model can be a finite element model of heat distribution on the surface of a composite material inside the autoclave. Based on a comparison between temperatures from the thermocouple agents and results of the supervisory mode, a malfunctioning thermocouple can be determined and eliminated.

### TECHNICAL FIELD

The subject disclosure relates to an autoclave utilized in a composite curing process and, more particularly, to an intelligent controller associated with the autoclave that can provide autonomous control of the composite curing process.

### BACKGROUND

Composite curing can be accomplished through proper application of heating and cooling to composite material inside autoclaves or automated ovens. Composite materials are cured under very stringent specifications. For example, specifications (e.g., control recipes and/or profiles) can relate to temperature, pressure and/or vacuum conditions. Generally, temperature specifications are the most important. Millions of dollars of composite materials could be lost during one imperfect curing process run: if composites are cured at a temperature that is too high, the material could become brittle and will be susceptible to breaking; on the other hand, if composites are cured at a temperature that is too low, the material may not bond correctly and will eventually come apart. However, the temperature specifications are generally difficult to control.

Classical control methods are utilized to monitor and control temperature within the autoclave. Thermocouples are attached to the composite material in a scattered pattern to monitor temperature within the autoclave. A leading thermocouple is selected and its temperature reading is fed back to a controller. Any malfunction of the leading thermocouple can lead to erroneous data being fed to the controller.

Although the curing process is performed in a controlled environment, there are dynamic perturbations affecting the thermocouples that could generate unsatisfactory results, and provoke a complete rejection of an expensive piece of composite material. For example, one perturbation could include a potential malfunctioning of a thermocouple itself. A malfunctioning thermocouple can appear healthy upon visual inspection, but its internal operations may generate inaccurate readings. Problems of this type are difficult to detect offline, so they often go undetected until the curing process has undergone several steps. Classical control programs residing in a controller do not possess the intelligence to early detect such problems.

Another type of problem can occur when a thermocouple detaches from the material during curing. The autoclave is a sealed controlled environment that cannot be interrupted to reattach the thermocouple. The controller is also generally unable to react to the failing thermocouple by performing corrective actions on the fly without disrupting the operation of the autoclave.

A viable solution to these problems can be to augment the intelligence and/or reasoning capability of the control system with more sophisticated reasoning algorithms. Such algorithms can follow the process to generate a model from it. Monitoring rules can be added to detect malfunctioning sensors. Typically, a PC work station is added to supervise the control system. This approach converts the solution into a centralized system, but the centralized system suffers from other problems, such as a single point of failure and connectivity issues, which exacerbate the problem of maintaining a robust system for the whole duration of the process.

### SUMMARY

The following presents a simplified summary of the claimed subject matter in order to provide a basic understanding of some aspects described herein. This summary is not an extensive overview, and is not intended to identify key/critical elements or to delineate the scope of the claimed subject matter. Its sole purpose is to present some concepts in a simplified form as a prelude to the more detailed description that is presented later.

According to an aspect, described is a method for autonomous control of a composite curing system. The method can comprise creating at least one control model corresponding to physical elements of the composite curing system. For example, the control model can be a hierarchical model of intelligent agents, wherein an autoclave agent corresponding to the autoclave is superior to a plurality of thermocouple agents corresponding one-to-one to a plurality of thermocouples scattered on the surface of a composite material. The method can also comprise creating at least one supervisory model for the composite curing system. For example, the at least one supervisory model can include a finite element model of heat distribution on the surface of the composite material. Temperature readings from the thermocouple agents can be compared to results of the supervisory model, and health of the thermocouples can be determined. If a thermocouple is determined to be damaged, the corresponding thermocouple agent can remove itself from the control model.

According to another aspect, described is an intelligent industrial controller configured to utilize at least one control model in conjunction with at least one supervisory model. The control model can be stored in memory. For example, the control model can be a hierarchical model of intelligent agents, wherein an autoclave agent corresponding to the autoclave is superior to a plurality of thermocouple agents corresponding one-to-one to a plurality of thermocouples scattered on the surface of a composite material. The supervisory model can include a finite element model of heat distribution on the surface of the composite material. Results from the at least one supervisory model can be received through an interface. A processor can compare temperature readings from the thermocouple agents to results of the supervisory model, and health of the thermocouples can be determined. If a thermocouple is determined to be damaged by its representative agent, the thermocouple device can be removed from the control loop to avoid misleading information. The representing agent can initiate at least one notification action within the agent community.

According to an aspect, described is an apparatus that creates a supervisory model of the composite curing system. The apparatus can include a memory configured to store a simulation library. The simulation library can include at least one autoclave model, at least one thermocouple model, and/or at least one composite material model. The apparatus can also include a processor configured to create a supervisory model for the composite curing system based at least in part on the simulation library. For example, the supervisory model can include a finite element model of heat distribution on the surface of the composite material. The processor is further configured to execute the supervisory model. The apparatus can also include an interface configured to output results of the execution to an industrial controller. According to an aspect, the apparatus can be local to the industrial controller.

The following description and annexed drawings set forth certain illustrative aspects of the specification. These aspects are indicative, however, of but a few of the various ways in which the principles of the specification can be employed. Other advantages and novel features of the specification will become apparent from the following detailed description of the specification when considered in conjunction with the drawings.

### BRIEF DESCRIPTION OF THE DRAWINGS

FIG. 1 is a block diagram representation of an exemplary industrial control system.

FIG. 2 is a block diagram representation of an exemplary industrial control system utilized in a composite curing process.

FIG. 3 is a block diagram representation of an exemplary intelligent agent.

FIG. 4 is a block diagram representation of an exemplary model of a composite curing system.

FIG. 5 is a block diagram representation of an exemplary system for configuring an intelligent controller to be employed in a composite curing process.

FIG. 6 is a block diagram representation of an exemplary system for configuring an intelligent controller to be employed in a composite curing process.

FIG. 7 is a process flow diagram of a method for automated control of a composite curing process.

FIG. 8 is a process flow diagram of a method for automated control of a composite curing process.

FIG. 9 is a process flow diagram of an exemplary autonomous control method for a composite curing process.

FIG. 10 is a block diagram of a computer operable to execute the disclosed aspects.

FIG. 11 is a schematic block diagram of an exemplary computing environment, according to an aspect.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing these aspects.

As used in this application, the terms “component,” “module,” “agent,” “tool,” “wrapper,” “algorithm,” “system,” “interface,” or the like are generally intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include input/output (I/O) components as well as associated processor, application, and/or application programming interface (API) components.

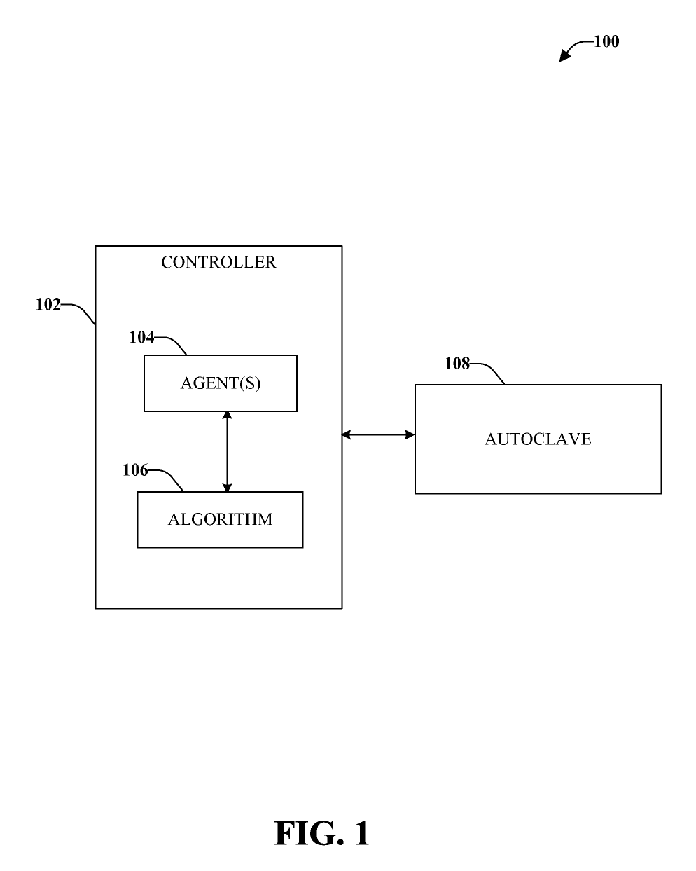

Referring initially to FIG. 1, illustrated is a block diagram illustration of an exemplary industrial control system 100, according to an aspect. According to an embodiment, the industrial control system 100 can be configured to control a composite curing process. Although the industrial control system 100 will be described herein as applied to a composite curing process, this is not meant to be limiting. A person having ordinary skill in the art will understand that the industrial control system 100 can control any number of industrial processes.

The industrial control system 100 can include a controller 102 that can be configured with advanced reasoning capabilities. For example, the controller 102 can be a programmable automation controller (PAC) and/or a programmable logic controller (PLC). The term “controller” as utilized herein can include functionality that can be shared across multiple components or networks. Additionally, a controller could be a hardware controller or a software controller.

According to an embodiment, the advanced reasoning capabilities can be provided to the controller 102 through agents 104. For example, agents 104 can be software components configured to encapsulate physical equipment knowledge and/or rules and/or properties in the form of capabilities. Capabilities can express the type of functions the agents 104 contribute to the well being of the system 100. Each capability can be a construct of behaviors. Each behavior can comprise sequentially organized procedures. Agents 104 can be integrated with a control algorithm 106 utilized by the controller 102.

The controller 102 can be configured to control at least one feature of a composite curing process. The composite curing process can be conducted in one or more autoclaves 108 or automated ovens. Although composite curing is described utilizing an autoclave 108, this is not meant to be construed as limiting. A person having ordinary skill in the art will understand that composite curing can be accomplished utilizing thermal profiles that do not require an autoclave. For example, composite curing can be accomplished in a facility (e.g., an oven and/or a heating enclosure) where temperature excursions required for the curing are not as extreme as required in an autoclave 108. Agents 104 can be utilized to control temperature in the oven and/or the heating enclosure, for example, to expedite the curing process and/or to reduce the amount of time required to cure the composite part (e.g., hardening of metallic parts).

The controller 102 can be configured to communicate with the one or more autoclaves 108 across a network. The network can be a public network (e.g., the Internet) or a private network (e.g., Common Industrial Protocol (CIP)). In another embodiment, the controller 102 can be integrated with the one or more autoclaves 108.

According to an aspect, the algorithm 106 can be an autonomous control program that controls temperature within the autoclave 108. The algorithm 106 can be written in any language supported by the controller 102; for example, ladder logic, function chart, script, JAVA, C code, and so on.

According to an aspect, the controller 102 can include a memory (not shown) and one or more processor(s). The algorithm 106 and the agent(s) 104 can be stored in the memory and executed by the one or more processors.

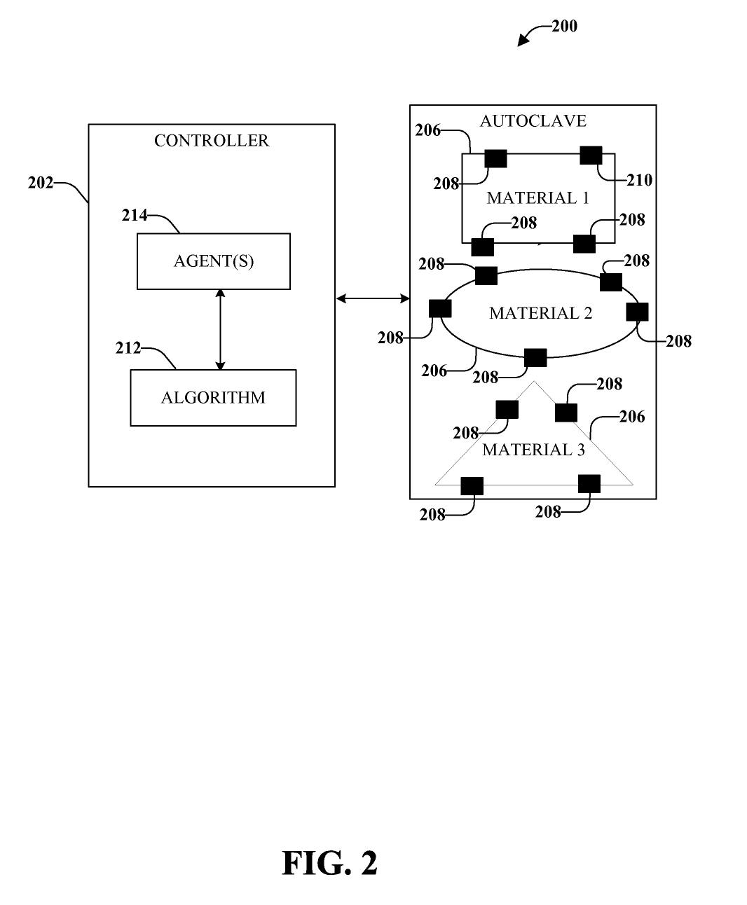

FIG. 2 is a block diagram illustration of an exemplary industrial control system 200 utilized in a composite curing process. The composite curing process can employ a controller 202 that can be configured to control the heating and cooling of a composite material 204 located inside an autoclave 206. Although a single composite material 204 is described herein, a person of ordinary skill in the art will understand that the autoclave 206 can heat and cool a plurality of composite materials 204 at a time. The plurality of composite materials 204 can include composite materials 204 of different shapes and/or sizes.

Thermocouples 208 can be attached to the composite material 204 scattered in different locations on the composite material 204. According to an aspect, the thermocouples 208 can be directly attached to the composite material 204. The thermocouples 208 can sense the temperature of the surface of a composite material within the autoclave 206 and feed temperature readings back to the controller 202. The controller 202 can be configured to employ a control loop, which can be driven, for example, by a proportional-integral-derivative (PID) loop. A leading thermocouple 210 can be selected from the thermocouples 208 to provide a representative material temperature within the autoclave 206 during the composite curing process to the controller 202. The controller 202 can be configured to utilize the temperature from the leading thermocouple in the control loop (e.g., the PID loop). Process control using the control loop depends on proper selection of the leading thermocouple 210. For example, the leading thermocouple 210 should provide an accurate representation of the material temperature within the autoclave 206 during the curing process. The leading thermocouple 210 can be selected, for example, according to a business rule.

Throughout the curing process, the leading thermocouple 210 can be damaged and rendered unusable. For example, the leading thermocouple 210 is exposed to high temperatures during the curing process, which may damage the leading thermocouple. In another example, the leading thermocouple 210 can become detached from the composite material. When the leading thermocouple 210 is rendered unusable, it is difficult to automatically reconfigure the system.

Generally, the leading thermocouple 210 can provide information about the ambient temperature in the autoclave 206 so that temperature profiles and/or temperature envelopes can selected in order for the controller 202 to set the next phase of the composite curing process, according to a curing profile for the composite material. Previous solutions have employed central workstations (e.g., central supervisors) remote from the controller 202 to select the temperature profiles and/or temperature envelopes and communicate selection to the controller 202 (e.g., across a network). However, if the controller 202 does not receive the selection, for example, because the network connection is broken, and/or the selection is incorrect, for example, because the leading thermocouple 210 is damaged, the controller 202 lacks the ability to dynamically self-organize to set the next phase of the composite curing process.

As opposed to previous solutions, the system 200 can employ an intelligent controller 202 that can possess self-organizing capabilities to set the next phase of the composite curing process in response to eventualities, such as a damaged leading thermocouple 210 and/or a broken network connection. For example, instead of utilizing a remote central workstation, the controller 202 can employ a local supervisor to select temperature profiles and/or temperature envelopes in order for the controller 202 to set the next phase of the composite curing process.

According to an embodiment, the controller 202 can be configured with a control algorithm 212 that can automatically reconfigure the system when the leading thermocouple 210 is rendered unusable. The algorithm 212 can be written in any control language supported by the controller 202; for example, ladder logic, function chart, script, JAVA, C code, and so on. The combined effect of the intelligent agents 214 and the control algorithm 212 can produce an autonomous curing control and diagnostics system.

The algorithm 212 can reconfigure the system based on communication with one or more intelligent agents 214. The intelligent agents 214 eliminate the need for human intervention in reconfiguring the control loop and/or selecting a new leading thermocouple 210. Agents 214 can also operate in an advisory mode. In the advisory model, the intelligent agents can recommend new configurations (e.g., shuffling lead thermocouple location) to a human operator and allow the human operator to make the changes.

For example, the intelligent agents 214 can be software wrappers that can encapsulate high-level material state control and curing process knowledge. Intelligent agents 214 can introduce intelligence and/or knowledge, traditionally employed through the central workstation, into the controller 202 itself, eliminating the need for the central workstation. For example, the intelligent agents 214 can encapsulate curing profiles, selection of an initial leading thermocouple 210, alarm analysis, execution of the curing profiles, diagnosis of the health of the leading thermocouple 210 and/or other thermocouples 208, alarm generation and/or if-then rules to continue state control without high-level supervision. According to an embodiment, the intelligent agents 214 can each include a software wrapper that encapsulates a step of the composite curing process.

Intelligent agents 214 can be stored in memory and execute on one or more processors. According to an embodiment, intelligent agents 214 can be executed by one or more processors on a controller 202 (e.g., a programmable logic controller [PLC]). According to an embodiment, the intelligent agents 214 can be built on workstations, compiled and then downloaded into the controller 202.

For example, the intelligent agents 214 can reconfigure the lead thermocouple 210. In an exemplary autoclave 206, more than one composite material can undergo composite curing at the same time. Thermocouples 208 can be located at various locations on the surface of the composite materials. To distinguish temperature profiles of the thermocouples 208 during the composite curing process, the thermocouples 208 can be associated with specific part ids. Associating the thermocouples 208 to the part ids can enable classification of static curing groups within the autoclave 206. These static groups can be associated with thermocouple agents 214 that can utilize the part id to carry out a second classification and organization of temperature profiles, thereby forming dynamic monitoring groups.

The agents 214 supervising the monitoring groups can execute thermocouple diagnostics based at least in part on a temperature estimation mechanism. The agents 214 can utilize the temperature profiles to assign rules to the thermocouples 208 in the different groups. For example, representative groups of thermocouples 208 can be selected as a leading thermocouple 210. According to an aspect, the selection of a leading thermocouple 210 can be inclusive to consider all parts under curing.

Dynamic processes affecting the reconfiguration and reselection of the leading thermocouple 210 can be a non-linear problem of high complexity. According to an embodiment, the assignment of the leading thermocouple 210 can be dynamically performed by the agents 214 once the thermocouple-to-part associations are established and can vary according to a state of the thermocouples 208 that can be rendered by the diagnostics and health assessment activity of the agents 214.

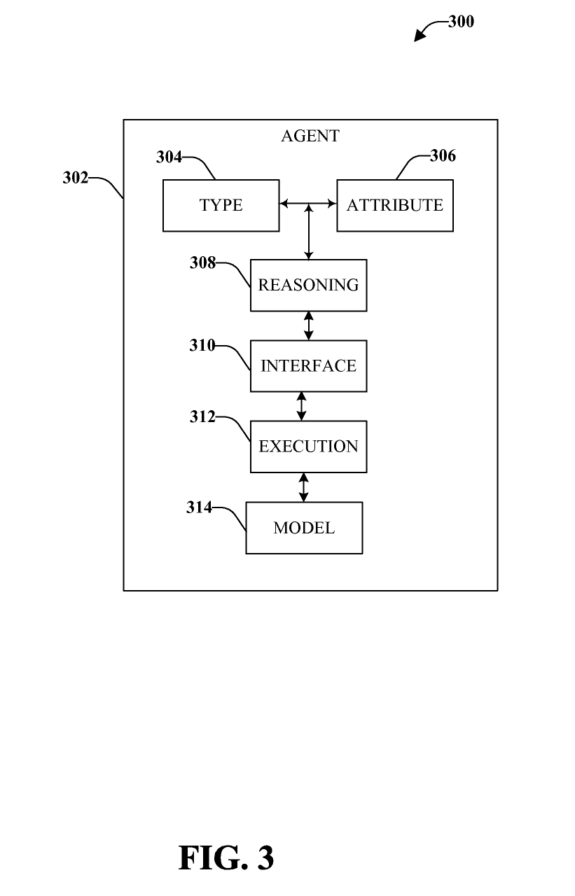

FIG. 3 is a block diagram representation 300 of an exemplary intelligent agent 302. One or more intelligent agents 302 can be configured to model the composite curing process. For example, each intelligent agent 302 can be configured to correspond to different aspects of the composite curing process. Each intelligent agent 302 can encapsulate knowledge and/or intelligence relating to different aspects of the composite curing process and communicate with each other to share such knowledge and/or intelligence. This exchange of knowledge can occur in a decision-making group in which the intelligent agents 302 can assess the state of the composite curing process. In a cooperative manner, the intelligent agents 302 can be more effective in determining deviating thermocouples. The decision making group can be dynamically formed by the involved agents, and need not involve all of the agents at once.

According to an aspect, intelligent agents 302 can be software agents that encapsulate the functionality of physical elements of the autoclave process. Each intelligent agent 302 can include a type 304 related to a physical element employed in the composite curing process. For example, a type 304 can indicate that the intelligent agent 302 is related to the autoclave, a thermocouple, or the composite material. Each intelligent agent 302 can include one or more configurable attributes 306. For example, an attribute 306 can include an operational range for the associated type 304.

The intelligent agent 302 can include reasoning capabilities 308, a data table interface 310 and/or execution control 312. Reasoning capabilities 308 can include behaviors that execute according to encapsulated rules. Rules can establish that execution of certain behaviors can be triggered in response to one or more events. Although most rules establish reactive behaviors in response to one or more events, rules can also incorporate proactive behaviors, such as the detection of deviating thermocouples.

Rules can, for example, be based upon the type 304. According to an aspect, the type 304 can be an autoclave type (“autoclave agent”) or a thermocouple type (“thermocouple agent”). Autoclave agents and thermocouple agents can have different rules that establish different behaviors. Autoclave agent can include rules that establish behaviors including requesting a reorganization of thermocouples in response to an event (e.g., an elapse of time or a particular temperature reading). Thermocouple agent can include rules that establish behaviors including continuously monitoring the temperature of the process and/or periodically monitoring and/or trending the condition of the thermocouple sensor in response to a request from an autoclave agent.

The intelligent agent 302 can also include a data table interface 310. A data table can serve as a data repository for data established by behaviors of the agent. The intelligent agent 302 can also include an execution control 312 aspect, which can execute the behaviors.

The intelligent agent can also include a virtual model 314. The virtual model 314 can be a simulation of one or more mechanical aspects of the composite curing process. For example, the virtual model 314 can be a simulation of mechanical aspects of the autoclave, the thermocouple, and/or the composite material. The virtual model 314 is local to the intelligent agent.

For example, the intelligent agent 302 can be related to a thermocouple type 304 (a thermocouple agent), modeling one thermocouple of the many thermocouples scattered at different places on the composite material. Different thermocouple agents can model the other thermocouples scattered at different places on the composite material. Each thermocouple agent corresponding to the many thermocouples is based on the same general template for a thermocouple agent, so that each thermocouple agent shares the same reasoning rules, but varies in personality (e.g., name, location, ranges, and the like). Each thermocouple agent can communicate with other intelligent agents 302, creating a highly reconfigurable logical structure modeling the thermocouples scattered at different places on the composite material during the composite curing process.

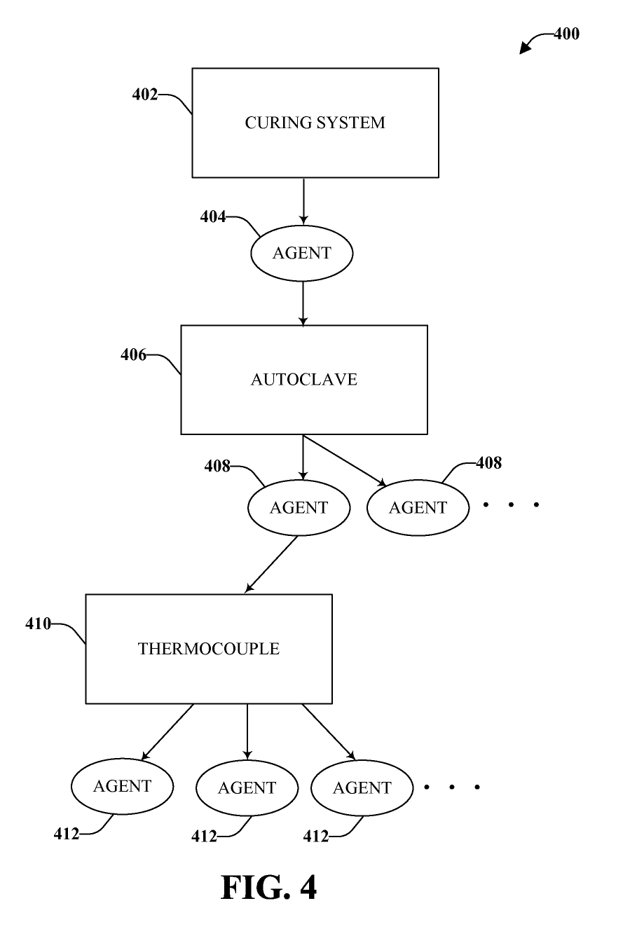

FIG. 4 is a block diagram representation of an exemplary model 400 of a composite curing system. The model 400 can be utilized by an industrial controller to model the composite curing process performed by the composite curing system. The model can include a hierarchical arrangement of the intelligent agents with each agent corresponding to a physical element of the composite curing system.

According to an aspect, the composite curing system can correspond to a three tier one-to-one system, since each physical device in the composite curing system can be isolated and classified into an independent work unit. The top level tier corresponds to a composite curing system layer 402. The composite curing system layer 402 can include an agent 404 representing the overall composite curing process. The second level tier corresponds to an autoclave layer 406, which includes every autoclave utilized in the composite curing process. The autoclave layer 406 can include at least one autoclave agent 408 representing autoclave machinery. One autoclave agent 408 can correspond to each piece of autoclave machinery. The third level tier corresponds to a thermocouple layer 410, which includes every thermocouple scattered on the composite material. The thermocouple layer 410 can include at least one thermocouple agent 412, with one thermocouple agent 412 per thermocouple.

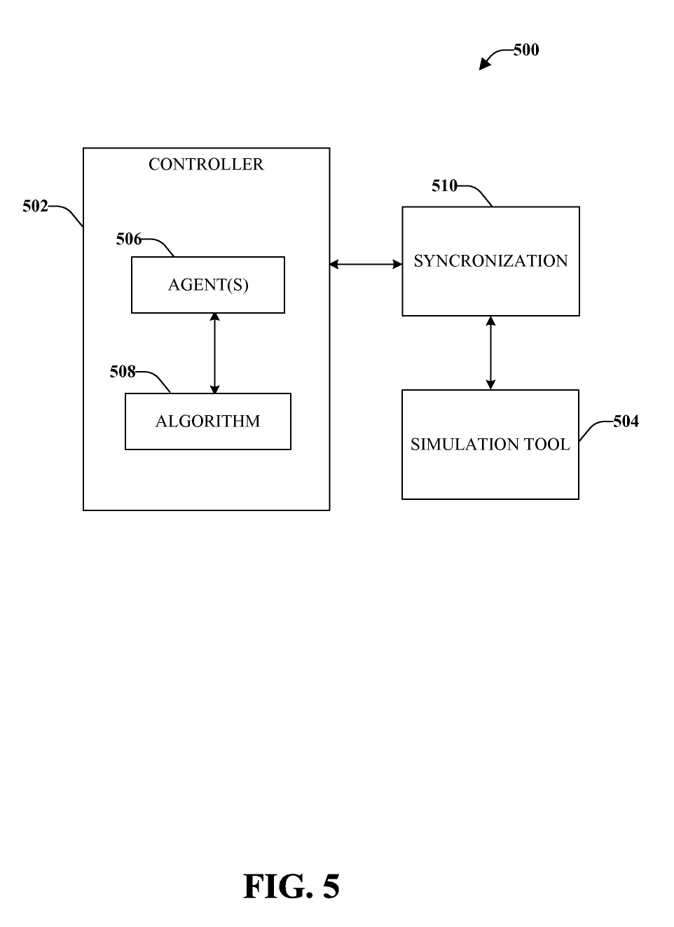

FIG. 5 is a block diagram illustration of an exemplary system 500 for configuring an intelligent controller 502 to be utilized in a composite curing process. The controller 502 can be configured to control the heating and cooling of a composite material located inside an autoclave during the composite curing process. The controller 502 can communicate with a configurable simulation tool 504, which can be configured to simulate the composite curing process and provide results to the controller 502.

The controller 502 can include intelligent agents 506 that can model control aspects of the composite curing process and an algorithm 508 that can control the composite curing process (e.g., temperature adjustments). Because the composite curing process occurs in a sealed autoclave, in many cases the control aspects alone may not be able to adjust for irregularities within the control system, like a damaged thermocouple, for example. The simulation tool 504 can provide a model of supervisory aspects of the composite curing process. This simulation can be global to the composite curing process.

For example, the simulation tool 504, which can model the supervisory aspects of the composite curing process, can model diagnostics for the composite curing process, which can diagnose a malfunctioning thermocouple. When a malfunctioning thermocouple is detected, the intelligent agents 506 can reconfigure the physical system, for example by selecting another representative thermocouple as the lead, to enable a continuous, uninterrupted composite curing process.

The simulation tool 504 can model the supervisory aspects of the composite curing process by modeling machine properties, for example properties of the autoclave and/or the thermocouples, and material properties, for example properties of the composite material.

According to an embodiment, the simulation tool 504 can utilize one or more finite element model to simulate thermal behaviors of the composite material. Heat transfer differential equations can be utilized with the finite element model to calculate an accumulation and/or a dissipation of heat on at least one node of the finite element model. The finite element model can be subjected to anisotropic properties to mimic heat accumulation and/or dissipation rates through the composite material. The simulation tool 504 can output the average temperature at a specific location on the composite material as determined by the finite element model to the controller 502. The system can include a synchronization element 510 that can enable and/or permit clock and data exchange synchronization between the simulation tool 504 and the controller 502.

For example, the simulation tool 504 can output an array of temperatures at specific points on the composite material (e.g., the specific points can correspond to locations of the thermocouples). The controller 502 can employ agents 506 to manage the composite curing process. For example, the agents 506 can include an autoclave agent that communicates with one or more thermocouple agents that correspond to the thermocouples on the composite material. The autoclave agent can request temperature readings (e.g., trending and/or standard deviations) from the thermocouple agents and compare the temperature readings to the array of temperatures. The autoclave agent can determine deviations in the temperature readings from the array of temperatures which can indicate failure of a thermocouple.

According to an embodiment, when the autoclave agent determines that a thermocouple has failed (e.g., if the temperature reading of the thermocouple falls outside a curing temperature profile), the thermocouple agent associated with that thermocouple can decide to remove itself from any further calculations. The autoclave agent can reorganize the remaining thermocouple agents (e.g., create a new sensor array of thermocouples) in response to the thermocouple agent that has removed itself from further calculations. If the departing thermocouple was the leading thermocouple, a new leading thermocouple can be determined from the remaining thermocouples.

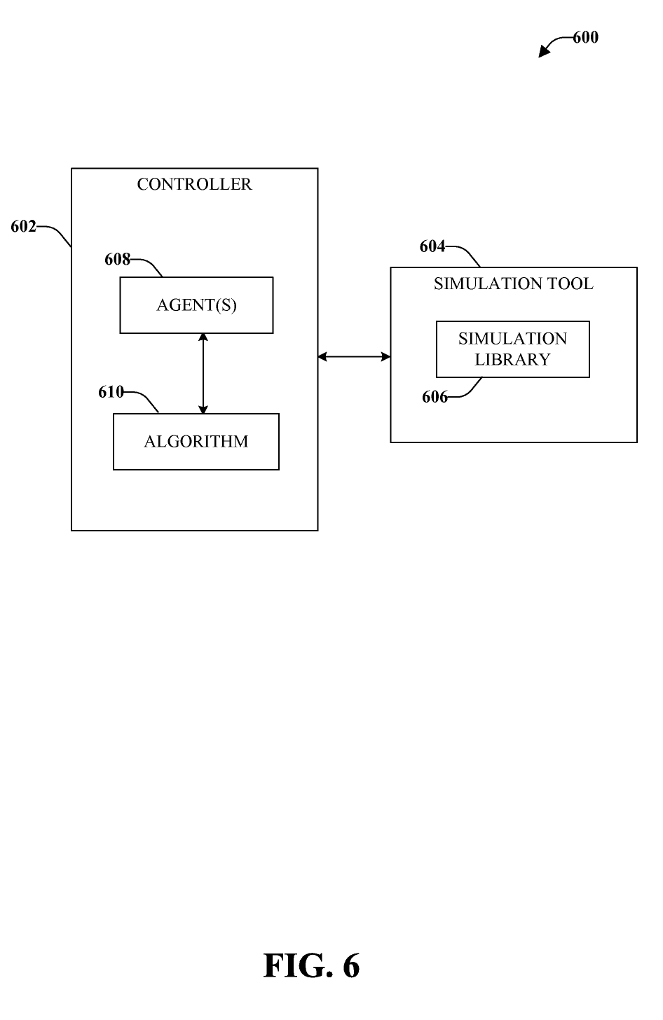

FIG. 6 is a block diagram representation of an exemplary system 600 for configuring an intelligent controller 602 to be employed in a composite curing process. The controller 602 can be configured to control the heating and cooling of a composite material located inside an autoclave during the composite curing process. The controller 602 can communicate with a configurable simulation tool 604, which can be configured to simulate the composite curing process and provide results to the controller 602. The controller 602 and the simulation tool 604 can work in combination to relocate at least a portion of high-level material state control from a central workstation traditionally employed in composite curing processes. For example, the simulation tool 604 can be configured to provide the controller 602 with knowledge about the composite curing process, such as curing profiles, selection of an initial lead thermocouple, alarm analysis, execution of the curing profiles, diagnosis of thermocouple health, alarm generation, and/or if-then rules to continue state control without high-level supervision.

The simulation tool 604 can include a configurable simulation library 606. According to an aspect, the simulation library 606 can be configured to store simulations related to the composite curing process. For example, the simulation library 606 can include simulations of physical aspects of the composite curing process, including finite element models of an autoclave, thermocouples, and/or the composite material (e.g., based on geometrical distributions of thermocouples on the composite material). The simulation library can also include simulations of cooling processes and heating processes within the autoclave and associated exothermal effects. The simulation library 606 can be configured to expose an input/output (I/O) interface to be connected and synchronized with the controller 602. Outputs from the simulation library can be used by the controller 602 (e.g., by intelligent agents 608 and/or a control algorithm 610), for example, to model at least a portion of supervisory aspects of the composite curing process.

According to an embodiment, the simulation tool 604 can be located at a workstation (e.g., a computer remote from the controller 602) and communicate with the controller 602 across a network (not shown). According to another embodiment, the simulation tool 604 can be local to the controller 602.

The simulation tool 604 can include an interface (e.g. a graphical user interface, not shown) that displays a configuration panel. For example, the configuration panel can allow adjustment of the amount of heat entering a particular region of the composite material. According to an embodiment, the configuration panel can include a scrollbar panel.

In view of exemplary systems shown and described above, methodologies that may be implemented in accordance with the disclosed subject matter, will be better appreciated with reference to various flow charts. While, for purposes of simplicity of explanation, methodologies are shown and described as a series of blocks, it is to be understood and appreciated that the various embodiments described herein are not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g. device, system, process, component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

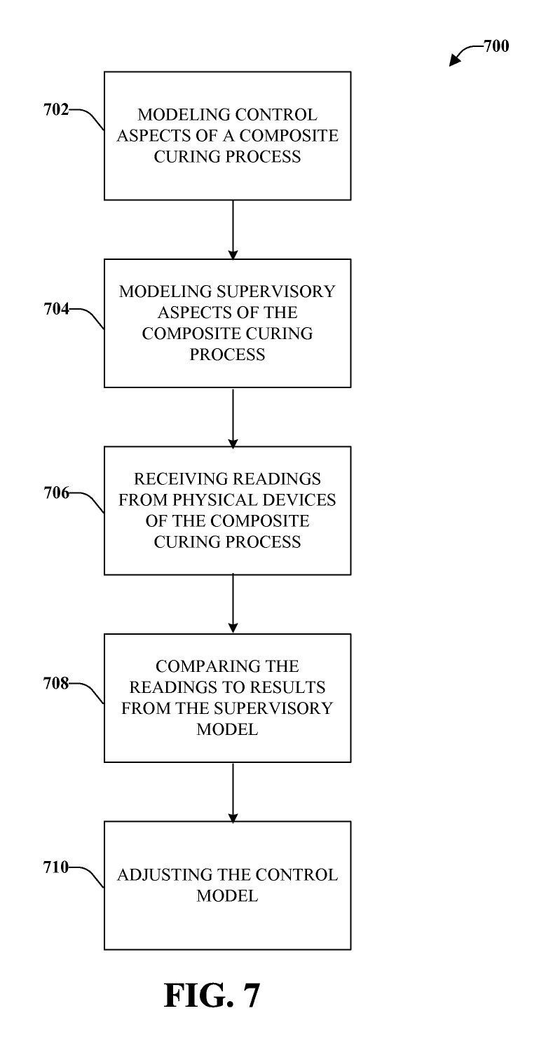

FIG. 7 is a process flow diagram 700 for an aspect of a method for automated control of a composite curing process. At element 702, a model of control aspects of a composite curing process can be created. According to an aspect, the model can include intelligent agents that correspond to physical elements of the composite curing process. For example, an autoclave agent can correspond to the autoclave. The autoclave agent can communicate with a plurality of thermocouple agents corresponding in a one-to-one fashion to a plurality of thermocouples scattered on the surface of the composite material in the autoclave. The autoclave agent can request temperature readings from the thermocouple agents and adjust the temperature of the autoclave based on the readings. In many cases, the control model alone may not be able to adjust for irregularities within the control system. For example, if a thermocouple is damaged and producing erroneous temperature readings, the control model alone cannot determine that the temperature readings are erroneous.

The state of the simulation can be periodically validated by the agents using the process state information. A curing process that executes with no failures in the simulation can generate temperature profiles that can be compared to the profiles from the real process. In this manner, a first level detection can be achieved by the agents. Agents can pinpoint the deviating location in the process for identifying the most likely failing thermocouple.

At element 704, a model of supervisory aspects of the composite curing process can be created. According to an aspect, the model can include diagnostic aspects of the composite curing process, which can diagnose malfunctioning thermocouples. For example, the model can include properties of the autoclave, the thermocouples, and/or the composite material. According to an embodiment, the model can simulate temperatures at various points on the composite material (e.g., at points where the thermocouples are located).

At element 706, readings from the thermocouple sensors can be requested. For example, the autoclave agent can request temperature readings from the thermocouple agents corresponding to the thermocouple sensors. At element 708, the readings can be compared to the results from the simulation. The results from the simulation can provide a range of acceptable temperatures (e.g., a temperature envelope) that the readings should fall between. According to an embodiment, the autoclave agent can determine that a reading corresponding to a thermocouple falls outside the range of acceptable temperatures of the simulation and that the thermocouple has failed. At element 710, the control model can be adjusted based on the comparison. For example, if the autoclave agent determines that the thermocouple has failed, the thermocouple agent corresponding to the thermocouple can remove itself from the control model.

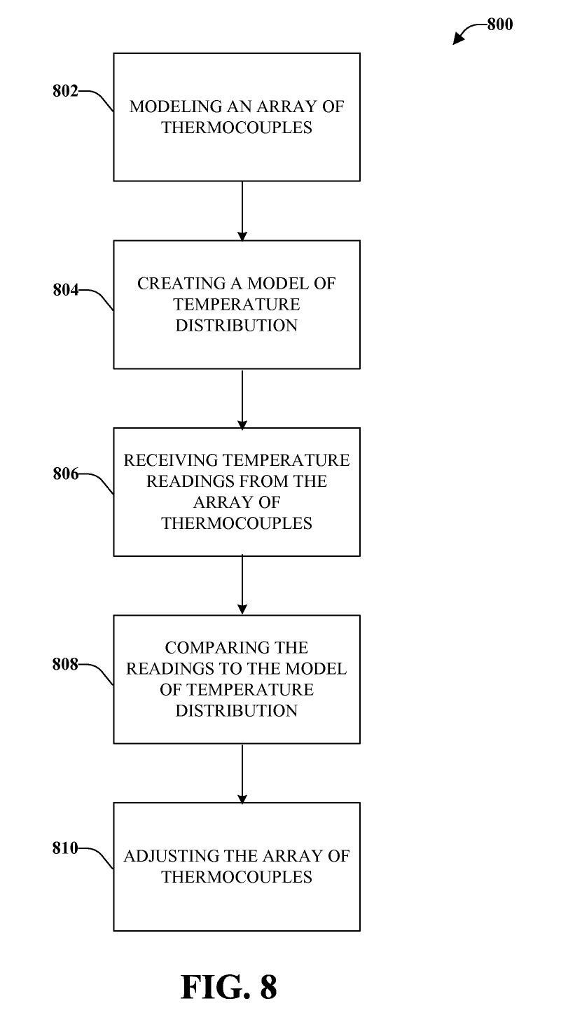

FIG. 8 is a process flow diagram 800 for an exemplary method for automated control of a composite curing process. At element 802, a model of an array of thermocouples can be created. According to an aspect, the model can include intelligent agents that correspond to physical elements of the composite curing process. For example, an autoclave agent can correspond to the autoclave. The autoclave agent can communicate with a plurality of thermocouple agents corresponding in a one-to-one fashion to a plurality of thermocouples scattered on the surface of the composite material in the autoclave. The autoclave agent can structure the thermocouple agents in an array of thermocouples. The autoclave agent can request temperature readings from the thermocouple agents and adjust the temperature of the autoclave based on the readings. In many cases, the control model alone may not be able to adjust for irregularities within the control system. For example, if a thermocouple is damaged and producing erroneous temperature readings, the control model alone cannot determine that the temperature readings are erroneous.

At element 804, a model of temperature distribution on the surface of the composite material can be created. The model of temperature distribution can include diagnostic aspects of the composite curing process, which can diagnose malfunctioning thermocouples. For example, the model of temperature distribution can be one or more finite element models that can simulate thermal behaviors of the composite material. Heat transfer differential equations can be utilized with the finite element model to calculate an accumulation and/or a dissipation of heat on at least one node of the finite element model. The finite element model can be subjected to anisotropic properties to mimic heat accumulation and/or dissipation rates through the composite material. The model of temperature distribution can output the average temperature at a specific location on the composite material (e.g., locations of the thermocouples).

At element 806, the autoclave agent can request temperature readings from the array of thermocouples, where each thermocouple agent can provide temperature readings to the autoclave agent. At element 808, readings from the array of thermocouples can be compared to the average temperatures at the specific locations from the model of temperature distribution. The average temperatures can provide a range of acceptable temperatures (e.g., a temperature envelope) that the readings from the array of thermocouples should fall between. According to an embodiment, the autoclave agent can determine that a reading corresponding to a thermocouple falls outside the range of acceptable temperatures of the simulation and that the thermocouple has failed. At element 810, the array of thermocouples can be adjusted based on the comparison. For example, if the autoclave agent determines that the thermocouple has failed, the thermocouple agent corresponding to the thermocouple can remove itself from the array of thermocouples.

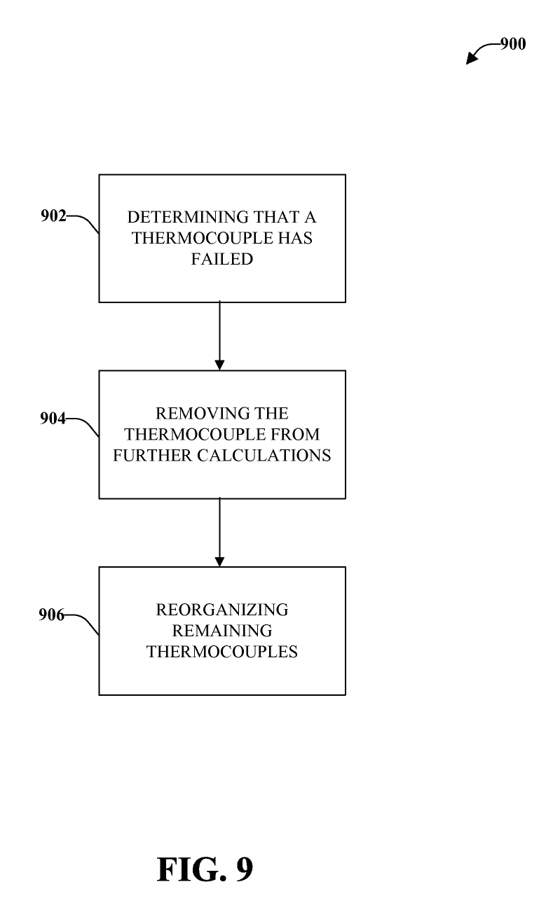

FIG. 9 is a process flow diagram 900 of an exemplary autonomous control method for a composite curing process. At element 902, an autoclave agent can determine that a thermocouple has failed. For example, the autoclave agent can request temperature readings from a plurality of thermocouple agents corresponding to a plurality of thermocouple sensors scattered on the surface of a composite part in the autoclave. According to an embodiment, the plurality of thermocouple agents can be in an array of thermocouple agents utilized by the autoclave agent to control the temperature of the composite curing process. The autoclave agent can compare the readings to a simulation of heat distribution on the surface of the composite material. If the temperature reading falls outside the simulation (e.g., outside of a temperature envelope), the autoclave agent can determine that the thermocouple associated with the reading has failed.

At element 904, the thermocouple agent associated with the failed thermocouple can decide to remove itself from the control process (e.g., the thermocouple agent can remote itself from any further temperature calculations and/or temperature readings).

At element 906, the autoclave agent can reorganize the remaining thermocouple agents. For example, the autoclave agent can create a new array of thermocouples agents without the agent corresponding to the failed thermocouple. If the failed thermocouple was a leading thermocouple, a new leading thermocouple can be determined from the remaining thermocouples.

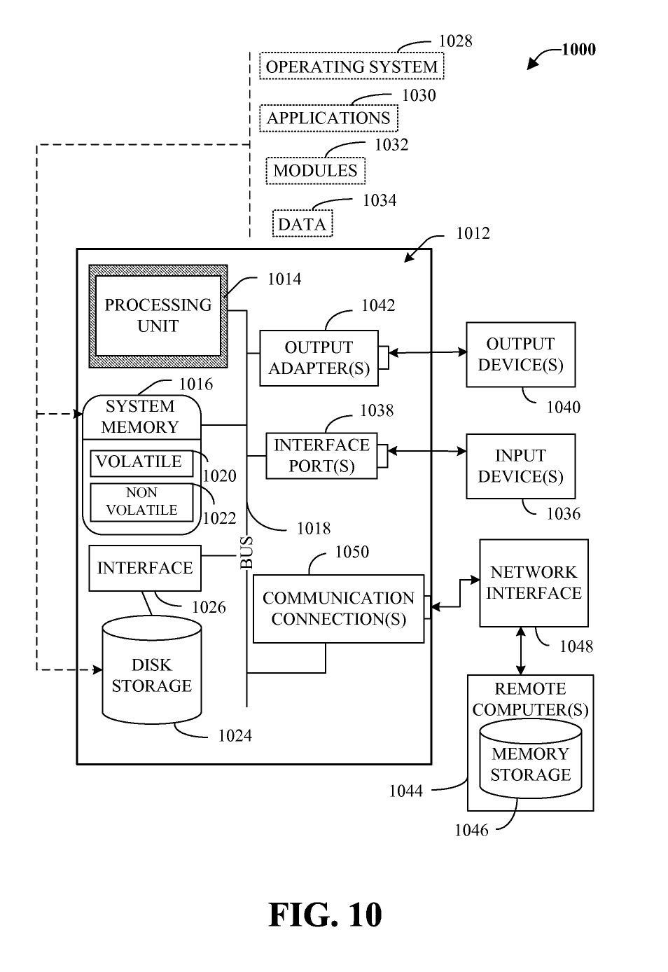

Referring now to FIG. 10, illustrated is a block diagram of a computer operable to execute the disclosed system. In order to provide additional context for various aspects thereof, FIG. 10 and the following discussion are intended to provide a brief, general description of a suitable computing environment 1000 in which the various aspects of the embodiment(s) can be implemented. While the description above is in the general context of computer-executable instructions that may run on one or more computers, those skilled in the art will recognize that the various embodiments can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the various embodiments may also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium. Communications media typically embody computer-readable instructions, data structures, program modules or other structured or unstructured data. By way of example, and not limitation, communication media include wired media and wireless media.

With reference again to FIG. 10, the illustrative environment 1000 for implementing various aspects includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1094 interface technologies. Other external drive connection technologies are within contemplation of the various embodiments described herein.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the illustrative operating environment, and further, that any such media may contain computer-executable instructions for performing the methods of the disclosed subject matter.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is to be appreciated that the various embodiments can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1094 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adaptor 1056 may facilitate wired or wireless communication to the LAN 1052, which may also include a wireless access point disposed thereon for communicating with the wireless adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are illustrative and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet without wires. Wi-Fi is a wireless technology similar to that used in a cellular phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10BaseT wired Ethernet networks used in many offices.

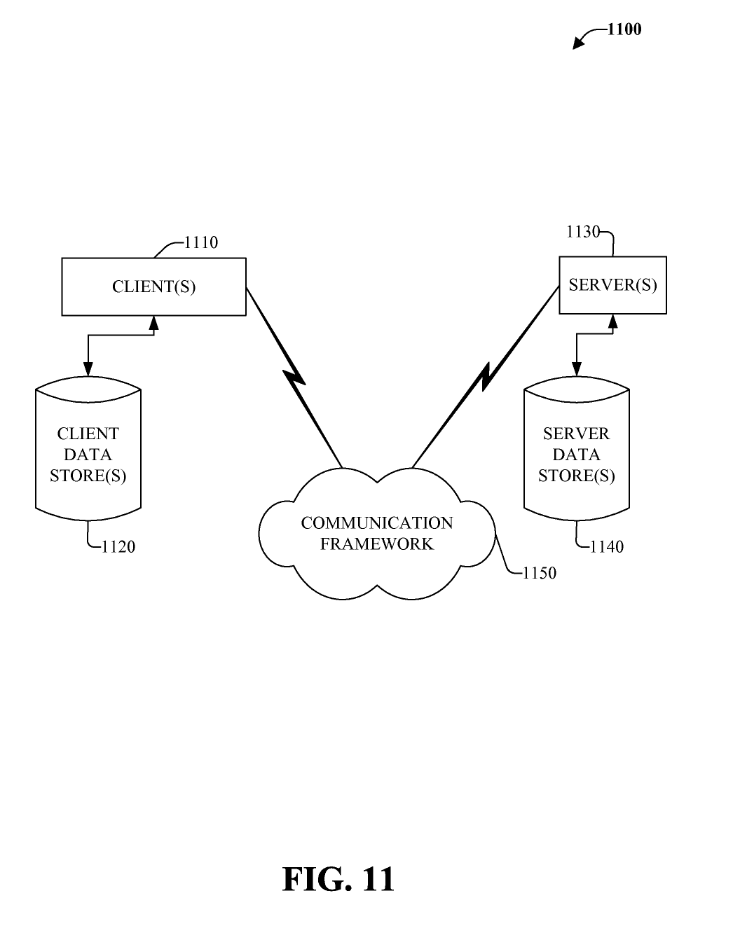

Referring now to FIG. 11, illustrated is a schematic block diagram of an illustrative computing environment 1100 for processing the disclosed architecture in accordance with another aspect. The system 1100 includes one or more client(s) 1102. The client(s) 1102 can be hardware and/or software (e.g., threads, processes, computing devices). The client(s) 1102 can house cookie(s) and/or associated contextual information in connection with the various embodiments, for example.

The system 1100 also includes one or more server(s) 1104. The server(s) 1104 can also be hardware and/or software (e.g., threads, processes, computing devices). The servers 1104 can house threads to perform transformations in connection with the various embodiments, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

It is noted that as used in this application, terms such as “component,” “module,” “system,” and the like are intended to refer to a computer-related, electro-mechanical entity or both, either hardware, a combination of hardware and software, software, or software in execution as applied to an automation system for industrial control. For example, a component may be, but is not limited to being, a process running on a processor, a processor, an object, an executable, a thread of execution, a program and a computer. By way of illustration, both an application running on a server and the server can be components. One or more components may reside within a process or thread of execution and a component may be localized on one computer or distributed between two or more computers, apparatuses, or modules communicating therewith.

The subject matter as described above includes various exemplary aspects. However, it should be appreciated that it is not possible to describe every conceivable component or methodology for purposes of describing these aspects. One of ordinary skill in the art may recognize that further combinations or permutations may be possible. Various methodologies or architectures may be employed to implement the various embodiments, modifications, variations, or equivalents thereof. Accordingly, all such implementations of the aspects described herein are intended to embrace the scope and spirit of subject claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method, comprising:
employing a processor to execute at least one supervisory model stored in memory to simulate an industrial process;
outputting at least one result from the at least one supervisory model;
receiving readings from physical elements of the industrial process;
employing the processor to compare the readings to the at least one result at least one control model corresponding to the physical elements;
employing the processor to determine that at least one of the physical elements is damaged based at least in part on the comparing; and
employing the processor to remove the at least one of the physical elements from the at least one control model.

2. The method of claim 1, further comprising creating the at least one control model, comprising:
modeling an autoclave with an autoclave agent;
modeling a plurality of thermocouples on to least one composite material in the autoclave with a plurality of thermocouple agents, wherein the autoclave agent is superior to the plurality of thermocouple agents;
establishing a communication between the autoclave agents and the plurality of thermocouple agents corresponding in a one-to-one fashion with the plurality of thermocouples; and
arranging the plurality of thermocouple agents in an array of thermocouples,
wherein the industrial process is a composite curing process.

3. The method of claim 1, further comprising creating the at least one supervisory model, comprising creating at least one model of diagnostic aspects for the industrial process.

4. The method of claim 1, further comprising creating the at least one supervisory model, comprising modeling properties of at least one of an autoclave, a plurality of thermocouples, or at least one composite material, wherein the industrial process is a composite curing process.

5. The method of claim 1, further comprising creating the at least one supervisory model, comprising creating a finite element model of the industrial process.

6. The method of claim 1, wherein the outputting the at least one result further comprises outputting an array of temperatures at a plurality of points on at least one composite material corresponding to a plurality of locations of a plurality of thermocouples, wherein the industrial process is a composite curing process.

7. The method of claim 1, wherein the receiving the readings further comprises receiving a plurality of temperature readings from a plurality of thermocouples, wherein the industrial process is a composite curing process.

8. The method of claim 1, wherein the receiving the readings further comprises receiving a plurality of temperature readings from a plurality of thermocouple agents corresponding one-to-one with the plurality of thermocouples, wherein the industrial process is a composite curing process.

9. The method of claim 1, wherein the determining that at least one of the physical elements is damaged further comprises determining that at least one temperature reading corresponding to at least one thermocouple falls outside a temperature envelope output from the at least one simulation model, wherein the industrial process is a composite curing process.

10. The method of claim 1, further comprising reorganizing the control model.

11. An industrial controller, comprising:
a memory configured to store a control model corresponding to physical elements of an industrial process;
an interface configured to receive results from at least one simulation of the industrial process; and
a processor configured to receive readings from the physical elements of the industrial process, make a comparison by comparing the readings from the physical elements to the results from the at least one simulation and adjust the control model based at least in part on the comparison.

12. The industrial controller of claim 11, wherein the control model comprises an autoclave agent corresponding to an autoclave superior to a plurality of thermocouple agents corresponding in a one-to-one basis to a plurality of thermocouple sensors, wherein the industrial process is a composite curing process.

13. The industrial controller of claim 12, wherein the autoclave agent arranges the plurality of thermocouple agents into an array of thermocouples.

14. The industrial controller of claim 11, wherein the at least one simulation comprises a finite element model of the industrial process.

15. The industrial controller of claim 14, wherein the results from the at least one simulation comprise a distribution of temperatures at a plurality of locations on the surface of at least one composite material, wherein the industrial process is a composite curing process.

16. The industrial controller of claim 11, wherein the processor is further configured to receive temperature readings of a plurality of thermocouples from a plurality of thermocouple agents, wherein the plurality of thermocouple agents correspond to the plurality of thermocouples on a one-to-one bases, wherein the industrial process is a composite curing process.

17. The industrial controller of claim 16, wherein the processor is further configured to make a comparison by comparing the temperature readings from the plurality of thermocouple agents to simulated temperatures from the at least one simulation and adjust remove at least one thermocouple agent from the control model based at least in part on the comparison.

18. An apparatus configured to communicate with an industrial controller, comprising:
a memory configured to store a simulation library for an industrial process, wherein the simulation library comprises at least of at least one autoclave model, at least one thermocouple model, or at least one composite material model;
a processor configured to create a supervisory model for the industrial process based at least in part on the simulation library and execute the supervisory model; and
an interface configured to output results from the supervisory model to the industrial controller that controls the industrial process.

19. The apparatus of claim 18, wherein the supervisory model comprises a finite element model of heat the industrial process.

20. The apparatus of claim 19, wherein the results from the supervisory model further comprise temperatures at a plurality of positions on the surface of the at least one composite material, wherein the industrial process is a composite curing process.
